(19) United States
(12) Patent Application Publication
(10) Pub. No.: US 2020/0232833 A1
(43) Pub. Date: Jul. 23, 2020

(54) ANALOG FLUID CHARACTERISTIC SENSING DEVICES AND METHODS

(71) Applicant: Hewlett-Packard Development Company, L.P., Spring, TX (US)

(72) Inventor: Patrick V. Boyd, Albany, OR (US)

(21) Appl. No.: 16/482,233

(22) PCT Filed: Apr. 14, 2017
(86) PCT No.: PCT/US2017/027568

§ 371 Date: Jul. 30, 2019

(51) Int. Cl. G01F 23/24; G01N 27/06

(52) U.S. Cl. CPC G01F 23/243; G01N 27/06; G01F 23/246

(57) ABSTRACT

A fluid characteristic sensing device has a projection. The fluid characteristic sensing device receives current pulses and directs the received current pulses through the projection. The received and directed current pulses enable determination of a resistance of the projection and a rate of change of temperature.

### BACKGROUND

In a number of situations, fluids may be stored in a reservoir. Some example devices may allow determination of fluid characteristics, such as to enable estimation of fluid depth in the reservoir, by way of non-limiting example.

### BRIEF DESCRIPTION OF THE DRAWINGS

Various examples will be described below by referring to the following figures.

FIG. 1 is a schematic illustration of an example fluid characteristic measurement device;

FIG. 2 is a flowchart of an example method for enabling determination of resistance and temperature rate of change of a fluid characteristic sensing projection;

FIG. 3 illustrates an example fluid characteristic sensing device;

FIG. 4 illustrates another example fluid characteristic sensing device; and

FIGS. 5A and 5B show example fluid characteristic sensing devices in a reservoir.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

At times, there may be a desire to measure characteristics of a fluid. In different examples, a fluid for which characteristics are to be measured may comprise liquids, such as a print fluid or a 3D print agent, by way of non-limiting example. Example fluid characteristic sense devices may be arranged in printing fluid cartridges such as 2D or 3D print cartridges. Fluid volumes in example print fluid cartridges may range from approximately 1 ml to multiple liters, such as 25 L, by way of illustration. In one example, a fluid characteristic sense device may be associated with a comparatively small or medium-sized print cartridge, such as less than approximately 0.5 L, less than approximately 100 ml, or more than approximately 10 ml, by way of non-limiting example.

A number of methods and devices exist to sense fluid characteristics. In the following description, fluid characteristic sensing mechanisms, which may be capable of enabling fluid depth estimations, are discussed. By way of example, digital and analog fluid characteristic sensing devices may enable fluid depth estimation. In one case, while digital devices may be capable of providing depth estimates with greater accuracy than analog devices, they may also be more expensive. In contrast, analog devices may be less expensive than digital counterparts, but may be less accurate, by way of non-limiting example. There may be a desire, therefore, for analog devices capable of achieving accuracy levels that may approach those of digital fluid level sensing devices. The following description refers to fluid depth estimation as an example use of a fluid characteristic sensing device. However, it is to be understood that this is done without limitation or waiver as to claimed subject matter.

In one case, it may be possible to improve accuracy of an analog-type fluid characteristic sensing device by using additive or cumulative measurements of sensing mechanism and/or fluid characteristics. For example, additive fluid characteristic sensing measurements may measure multiple characteristics of portions of a sensing device immersed in fluid. The multiple characteristic measurements may be used in concert to provide greater accuracy as to fluid depth estimations than may be achieved by use of a single characteristic (e.g., resistance of a sensing device). By way of example, in one case, resistance and temperature measurements may be used in combination to yield a potentially more accurate fluid depth estimation.

In one example, a fluid depth estimate may be derived using resistance measurements of a probe of a sensing device. One example analog device, for example, may have one or more probes of a conducting material to be immersed in a fluid for which a depth estimate may be desired. Resistance of the probes may be measured, for example. The fluid in which the probes are immersed may be capable of conducting electricity. As such, a relationship may exist between levels to which probes are immersed in a fluid and probe resistance. Thus, if the probes have a known resistance in air, resistance measurements that deviate from the known value may be attributed to a volume of fluid into which the probes are immersed. Probe resistance measurements may therefore enable determinations of fluid conductivity and may be correlated with fluid depth levels.

In one example, a fluid depth estimate may be derived using temperature measurements of a probe of a sensing device. For instance, temperature measurements of a probe of a sensing device may be used to determine a rate of change of temperature of the probe. The rate of change of probe temperature may be used to estimate a fluid depth, which may be used in conjunction with a second fluid depth estimate based on measures of resistance of the probes to provide a potentially more accurate estimate of depth of a fluid. For instance, for a given probe of a sensing device (e.g., having a given material), a thermal response to a current pulse may be known (e.g., experimentally). In one case, for example, the probe may have a steady state temperature xₛₜ. The probe may reach a temperature xᵢ (from steady state) in a time t₁ in air, in response to a current pulse. In air, a temperature of the probe may return to a steady state value, xₛₜ, from temperature x₁ in a time t₂. A time for a temperature to change may vary based on a fluid volume in which a probe is immersed. For instance, in response to the current pulse, the probe may reach a temperature x₂ in a time t₃ while the probe is completely immersed in a particular fluid. And the probe may return to the steady state value xₛₜ in a time t₄ while the probe is completely immersed in the particular fluid. Depending on particular characteristics of the fluid in which the sensing device is immersed, a rate of change of temperature may be higher (e.g., the sensing device may heat and/or cool more quickly) or lower (e.g., the sensing device may heat and/or cool more slowly) while immersed. Through experimentation, for example, empirical values may be determined to correlate a rate of change of temperature on the one hand and fluid depth on the other (similarly, resistance values of a fluid characteristic sensing device may be empirically correlated with fluid depth). In one case, this may be done by taking temperature and/or rate of change of temperature measurements at a variety of fluid levels and using the measurements to provide reference values, such as in a lookup table, to estimate fluid depth. Thus, a measure of a rate of change of temperature of the probe may be used to estimate a fluid level. For instance, in one case, a time to heat or cool down a probe may be used to yield a fluid depth estimation.

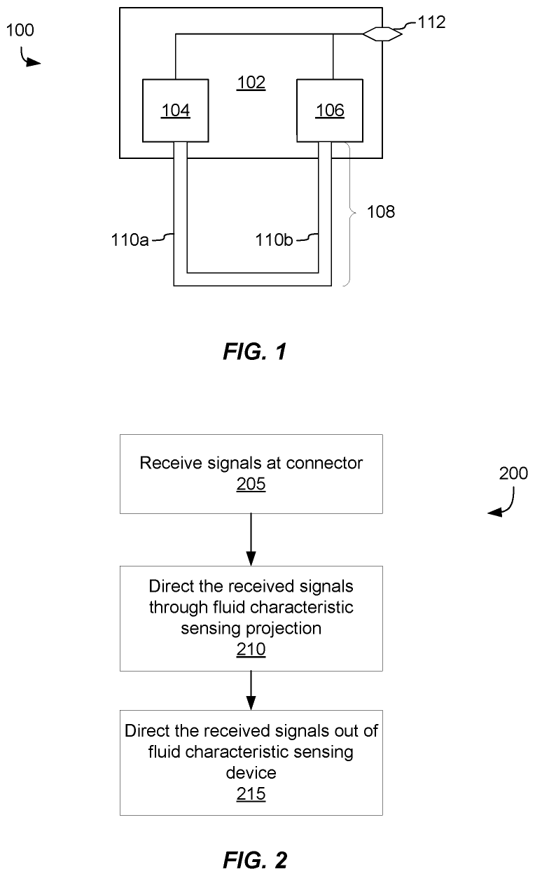

Thus, in one example case, fluid depth in a reservoir may be estimated using rate of change of temperature. Fluid depth may also be estimated using resistance-based measurements. The temperature-based fluid depth estimation and the resistance-based fluid depth estimation may thus be used together to yield a potentially more accurate fluid depth estimation. In one case, for example, the temperature-based fluid depth estimation and the resistance-based fluid depth estimation may be averaged. An example fluid characteristic sensing device capable of providing multiple measures of fluid characteristics is presented in the following paragraphs referring to FIG. 1.

An example fluid characteristic sensing device 100 is illustrated in FIG. 1 and may comprise a device for enabling estimation of a depth of fluid in a chamber. Thus, for example, fluid characteristic sensing device 100 may be used to estimate fluid depth in fluid reservoirs in manufacturing plants, automobile fuel tanks, printing fluid reservoirs, and other such situations in which measurements of fluid levels may be desirable.

In one example, fluid characteristic sensing device 100 may comprise a circuit board 102 to which a fluid characteristic sensing projection 108 may be connected. An I/O port 112 represents a portion of fluid characteristic sensing device 100 capable of directing signals away from fluid characteristic sensing device 100 and receiving signals, such as from a processor or a controller of a system (e.g., a printer) to which fluid characteristic sensing device 100 may be communicably connected. For example, I/O port 112 may comprise an array of electrical interconnects. Conductive traces may provide paths through which signals may be directed between I/O port 112 and connectors 104 and 106 (which may be referred to herein as signal connectors in the context of providing a communicable connection between elements of a device through which signals may travel), to which fluid characteristic sensing projection 108 may be connected (and through which signals may be transmitted and received).

Circuit board 102 may comprise a connection mechanism between processing and signal driving mechanisms of a larger system (e.g., a printer) to which fluid characteristic sensing device 100 might belong, and fluid characteristic sensing structures, such as fluid characteristic sensing projection 108. In one implementation, circuit board 102 may comprise a printed circuit board (PCB) on a silicon (Si) wafer, onto which circuit structures may be deposited and into which circuit structures may be formed, by way of non-limiting illustration. For example, conductive pads, such as connectors 104 and 106, may be formed on a Si die and may be used to provide an electrical connection between circuit board 102 and fluid characteristic sensing projection 108. I/O port 112 may also comprise conductive structures, such as electrical interconnects, that may allow fluid characteristic sensing device 100 to connect to a reception mechanism or receptacle, such as a part of a reservoir or container structure. For instance, in a case in which fluid characteristic sensing device 100 is used to estimate fluid depth in a reservoir for printing fluid, circuit board 102 may connect to a connection reception mechanism of a printer, which may be in communication with a processer of the printer. Signals may be transmitted via the connection reception mechanism and I/O port 112 of circuit board 102 in order to enable estimation of printing fluid depth in the reservoir of the printer, by way of example.

Fluid characteristic sensing projection 108 comprises a mechanism that may be used in a chamber (e.g., a fluid reservoir) and which may enable measurement of fluid characteristics capable of being used to yield fluid depth-related estimates, by way of non-limiting example. Fluid characteristic sensing projection 108 may comprise conductive components 110a and 110b. Fluid characteristic sensing projection 108 and conductive components 110a and 110b may comprise a material, such as a metal or metalloid, capable of conducting electricity. One factor to consider in selecting a material for fluid characteristic sensing projection 108 may be a material temperature versus resistance characteristic for the material and for which changes in temperature yield changes in resistance according to a substantially linear relationship. While the particular range of interest may vary based on an application (e.g., industrial, automotive, etc.) and fluid types (e.g., print fluid), in the case of an example operational temperature range for print fluids (e.g., approximately 15 degrees C. to approximately 35 degrees C.), Si has a substantially linear relationship of temperature versus resistance and a comparatively steep slope. Thus, for example, Si may comprise a sample material that may exhibit desirable characteristics. As such, in one case, fluid characteristic sensing projection 108 may comprise silicon strips (e.g., comprising polysilicon). One example material may be silicon-based, such as polysilicon. For example, thin strips of photovoltaic-grade polysilicon may be formed and used as conductive components 110a and 110b. In another example case, fluid characteristic sensing projection 108 may comprise steel wires having a polysilicon coating. Of course, these examples are merely provided to illustrate possible structures and are not to be understood in a limiting sense. Indeed, in one example, a number of metals and metalloids may operate suitably for desired functionality within desired temperate range. Of course, those of skill in the art will appreciate that it may also be desirable to confirm chemical compatibility of fluids to be measured and materials to use for fluid characteristic sensing projection 108. In the context of printing fluid reservoirs, other suitable materials for fluid characteristic sensing projection 108 may include NiChrome resistance wire, nickel, platinum, Constantan, tungsten, and copper, without limitation.

In one implementation of fluid characteristic sensing projection 108, resistance and rate of change of temperature measurements may be made based on measurements from fluid characteristic sensing projection 108 (e.g., signals may be yielded that may enable fluid depth level estimation). To illustrate, fluid characteristic sensing projection 108 may comprise first and second conductive components 110a and 110b (also referred to herein as probes). Current pulses may be received via I/O port 112, connector 104, and may be directed through first conductive component 110a. The current pulses may travel through first conductive component 110a and second conductive component 110b. The current pulses may travel via connector 106 and back out I/O port 112. The current pulses may be used to determine a resistance of fluid characteristic sensing projection 108 (e.g., such as by measuring a voltage differential across connectors 104 and 106 and solving for a resistance, where R=V/I). As noted, resistance of fluid characteristic sensing projection 108 may change based on fluid levels, such as based on a conductivity of a fluid. For instance, a different resistance may be measured at fluid characteristic sensing projection 108 for a same current pulse (e.g., a same pulse amperage and duration) depending on whether fluid characteristic sensing projection 108 is entirely immersed in a fluid versus partially immersed in the fluid.

As should be apparent, then, in response to signals transmitted to fluid characteristic sensing projection 108, signals may be received back at circuit board 102 that may be indicative of resistance of fluid characteristic sensing projection 108 (e.g., to enable resistance measurements). In addition, signals to enable a determination of a rate of change of temperature of fluid characteristic sensing projection 108 may also be received. In one example, a temperature of fluid characteristic sensing projection 108 may be measured to enable a determination of a rate of change of temperature. The determined rate of change may be compared with an expected rate of change of temperature for the applied current, such as expressed in time. In one case, the difference between the expected rate of change of temperature for the applied current and the measured rate of change of temperature may be used to estimate a fluid level. In one example, the relationship between fluid depth and rate of change of temperature may be determined experimentally for a particular fluid and a particular reservoir. Empirical results may be represented in a lookup table, for example. Together, fluid depth estimations derived based on resistance and a rate of change of temperature may provide increased accuracy as compared to an example case in which one measure (e.g., resistance alone) is used to estimate fluid depth.

The following discussion refers to portions of FIG. 1 to provide context for FIG. 2. FIG. 2 illustrates a sample method 200 for directing signals indicative of resistance and temperature (to enable rate of change of temperature determinations) through a fluid characteristic sensing projection 108 from FIG. 1. As indicated at block 205, one or more signals, such as in the form of current pulses, may be received at connector 104 or 106 of circuit board 102. The signals may be received from a system connected to fluid characteristic sensing device 100 (e.g., a printer). The signals may be received through I/O port 112, may traverse conductive traces from I/O port 112 to one or more of connector 104 and 106, and may traverse at least a portion of first and second conductive components 110a and 110b, such as shown in block 210 of example method 200. The signals may be directed out of fluid characteristic sensing device 100, such as via I/O port 112, as shown at block 215. The signals may enable estimation of a fluid depth in a reservoir, such as based on a resistance of fluid characteristic sensing projection 108. The signals may also enable determination of a temperature of fluid characteristic sensing projection 108. By way of non-limiting example, current or voltage values at fluid characteristic sensing projection 108 may be used to determine a temperature, such as by using a thermocouple arranged in a system to which fluid characteristic sensing projection 108 may be connected (e.g., a printer), by way of non-limiting example.

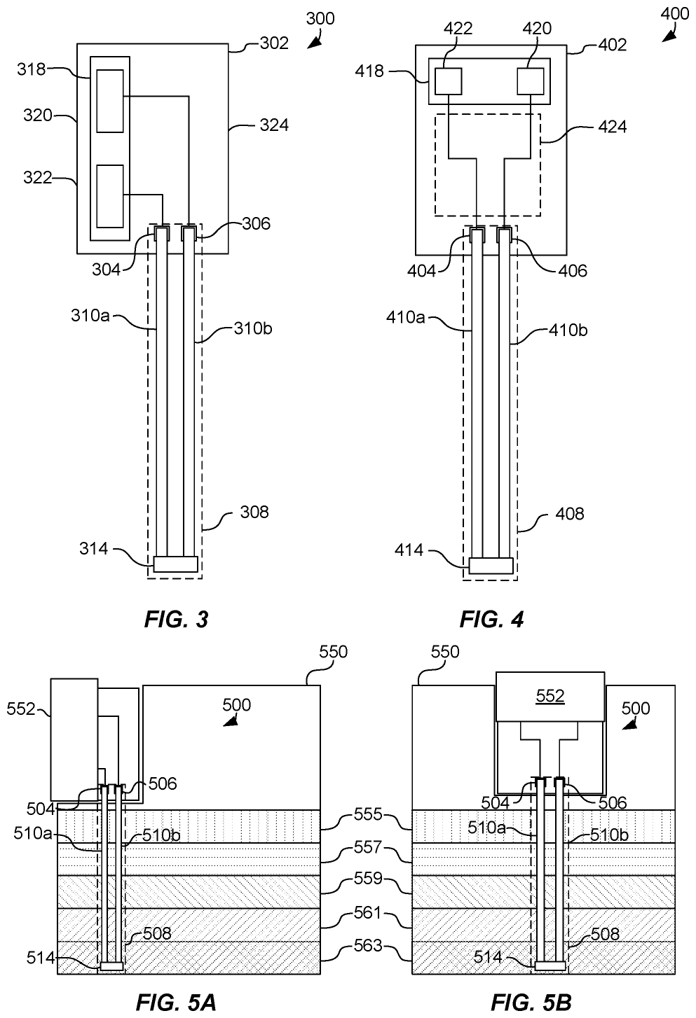

FIG. 3 comprises a view of a sample fluid characteristic sensing device 300. Fluid characteristic sensing device 300 comprises a circuit board 302 coupled to a fluid characteristic sensing projection 308 via connectors 304 and 306. Circuit board 302 also comprises electrical interconnects 318 which may be capable of providing an electrical connection to a processor external to fluid characteristic sensing device 300. Interconnects 318 may comprise a number of conductive pads, such as conductive pads 320 and 322, for providing an electrical connection to electrical components external to fluid characteristic sensing device 300. Conductive component connector 314 comprises a mechanism arranged at an extremity of fluid characteristic sensing projection 308, such as to provide a conductive path between first and second conductive components 310a and 310b.

In one example, fluid characteristic sensing device 300 may be relatively flat, such as to assist placement thereof in a compact space. For example, conductive components 310a and 310b and conductive component connector 314 may be relatively flat. In one example, fluid characteristic sensing projection 308 may be relatively thin, such as to yield a relatively flat fluid characteristic sensing device 300. For example, a thickness of fluid characteristic sensing projection 308 may be less than approximately 2 mm or less than approximately 1 mm, wherein the thickness may be measured perpendicular to a plane (e.g., square used to indicate fluid characteristic sensing device 308 of FIG. 3) extending through both first and second conductive components 310a and 310b. Also, conductive component connector 314 may be relatively thin, for example measured in a same direction as a thickness of fluid characteristic sensing projection 308. Conductive component connector 314 and fluid characteristic sensing projection 308 together may be less than approximately 2 mm or less than approximately 1 mm thick, as measured along a plane perpendicular to a plane through both first and second conductive components 310a and 310b (e.g., square used to indicate fluid characteristic sensing device 308 of FIG. 3). In one example, fluid characteristic sensing projection 308 of fluid characteristic sensing device 300 may be arranged inside a fluid reservoir that includes other components such as a backpressure regulator, by way of non-limiting example. Examples of backpressure regulators may comprise a flexible wall (e.g. an air bag), vent structure, or a capillary print fluid absorption structure. For example, fluid characteristic sensing device 300 can be disposed next to such a component of a backpressure regulator. In one example, fluid characteristic sensing device 300 may be arranged at a close distance from a fluid volume wall, for example, against it, or parallel to such a wall and within less than approximately 5 mm, less than approximately 3 mm, or less than approximately 1.5 mm in distance.

In one implementation, fluid characteristic sensing device 300 may enable fluid depth estimations for a fluid into which fluid characteristic sensing projection 308 is immersed. A process similar to example method 200 of FIG. 2 may be used, for example, in order to estimate a fluid depth. Similar to block 205 of example method 200, for example, one or more current pulses may be received at fluid characteristic sensing device 300, such as from a controller or processor of a device (e.g., a printer). For example, in a case in which the device to which fluid characteristic sensing device 300 is attached comprises a printer, a processor of the printer may transmit one or more current pulses to fluid characteristic sensing device 300, such as to enable estimation of a depth of printing fluid in a reservoir of the printer. The one or more current pulses may be received at interconnects 318. Interconnects 318 may be in electrical communication with wires or traces connected to the processor of the printer. As such, interconnects 318 may enable transmission and reception of signals between a processor and fluid characteristic sensing device 100.

Current pulses received at interconnects 318 may travel through traces 324 and on to fluid characteristic sensing projection 308, similar to as was discussed above in relation to block 210 of example method 200. In one implementation, first conductive component 310a may be communicably connected to a conductive pad of interconnects 318 corresponding to a path to a ground. Similarly, second conductive component 310b may be communicably connected to a conductive pad of interconnects 318 corresponding to a path over which current pulses may be directed. As such, in a case in which current pulses are received at interconnects 318 from an external source (e.g., a processor), they may travel through a conductive pad (e.g., conductive pad 320 or 322) of interconnects 318, through a corresponding trace of traces 324, and connector 306 and on to second conductive component 310b. The received current pulses may travel through second conductive component 310b, conductive component connector 314, and first conductive component 310a. In one example, current pulses may leave first conductive component 310a, traverse connector 304 and traces 324. The current pulses may traverse a conductive pad (e.g., conductive pad 320 or 322) of interconnects 318 and exit fluid characteristic sensing device 300, such as discussed above in relation to block 215 of example method 200. In one case, the current pulses may travel towards a ground arranged externally to fluid characteristic sensing device 300. The conductivity of first and second conductive components 310a and 310b and a fluid in which fluid characteristic sensing projection 308 is arranged may influence a flow of the received current pulses. And based on the characteristics of the fluid and fluid characteristic sensing projection 308, it may be possible to measure a resistance, such as based on the current pulses and the conductivity of the projection and fluid.

To illustrate how such signals indicative of resistance and temperature might be used to estimate a fluid depth in a reservoir, a non-limiting illustrative example is provided. For example, a processor of a device or a system may execute instructions to enable fluid depth estimation for a fluid in a reservoir. Responsive to execution of the instructions, a current pulse may be transmitted to a reservoir in which fluid characteristic sensing device 300 is arranged. The current pulse may be received by fluid characteristic sensing device 300, traverse fluid characteristic sensing projection 308, as described above, and current may leave fluid characteristic sensing device 300, such as towards a ground. The processor may be capable of measuring a voltage at fluid characteristic sensing device 300 and using the voltage and the current pulse value, determine a resistance value. As noted above, the resistance value may be determined based on signals indicative of a resistance of a fluid characteristic sensing projection 308 of fluid characteristic sensing device 300.

The processor in this example may enable transmission of a current pulse capable of heating first and second conductive components 310a and 310b (and likewise heating fluids in proximity to first and second conductive components 310a and 310b within the reservoir). In one implementation, a same current pulse used to measure resistance may be used to heat first and second components 310a and 310b, for example. Using one or more components of the system (e.g., a printer in one example), a temperature reading may be taken subsequent to transmission of the heating current pulse and may be influenced by the current pulse transmitted from the processor. A fluid level in the reservoir may influence a temperature generated in response to the current pulse. The temperature reading may thus correlate with fluid depth.

The processor in this example may also enable a determination of a time taken for the temperature to return to a steady state value. For instance, a temperature xₛₜ may correspond to a temperature of fluid characteristic sensing projection 308 (and surrounding printing fluid) at a steady state in which no heating current is applied. And a temperature xᵢ may correspond to a temperature of fluid characteristic sensing projection 308 (and surrounding printing fluid) responsive to a heating current pulse. Subsequently, a time may be measured for temperature xᵢ to return to the steady state temperature of xₛₜ. The resulting time and x₁-xₛₜ values may be used to determine a rate of change of temperature, which may be used to estimate a fluid depth, by way of example. The fluid depth estimation based on a rate of change of temperature may be used with the fluid depth estimation based on resistance to yield an updated fluid depth estimation.

FIG. 3 shows a side mounting implementation of fluid characteristic sensing device 300. Thus, in one such implementation, interconnects 318 communicably couple to a reception mechanism arranged at a side orientation of a reservoir. In contrast, FIG. 4 illustrates a top mounting implementation of fluid characteristic sensing device 400. Similar to fluid characteristic sensing device 300, fluid characteristic sensing device 400 comprises a circuit board 402 comprising interconnects 418 (having conductive pads 420 and 422) and traces 424. Connectors 404 and 406, traces 424, and conductive pads 420 and 422 may enable transmission and reception of signals through first and second conductive components 410a and 410b. Conductive component connector 414 provides a conductive connection between extremities of first and second conductive components 410a and 410b. Fluid characteristic sensing device 400 may operate in a manner similar to the above description of fluid characteristic sensing device 300. By way of example, current pulses may be received at interconnects 418 and may travel to fluid characteristic sensing projection 408. Responsive to the received current pulses, signals indicative of resistance and temperature of fluid characteristic sensing projection 408 may travel out of fluid characteristic sensing device 400.

In light of the foregoing description, an example fluid characteristic sensing device may comprise a circuit board (e.g., circuit board 302 in FIG. 3 and circuit board 402 in FIG. 4). The circuit board may comprise a first signal connector and a second signal connector (e.g., connectors 304 and 306 and connectors 404 and 406). The first signal connector and the second signal connector may provide a communicative connection between interconnects of the circuit board (e.g., interconnects 318 and interconnects 418) and a fluid characteristic sensing projection (e.g., fluid characteristic sensing projection 308 and fluid characteristic sensing projection 408). The fluid characteristic sensing projection may include a first conductive component (e.g., first conductive component 310a and first conductive component 410a) connected to the first signal connector. The fluid characteristic sensing projection may also include a second conductive component (e.g., second conductive component 310b and second conductive component 410b) connected to the second signal connector. In one example, the first and second conductive components are connected at one extremity (e.g., as shown connected by conductive component connector 314 and conductive component connector 414). The fluid characteristic sensing projection is to receive, through the first signal connector, signals for estimation of fluid depth. In response to the to be received signals, signals indicative of a resistance of the fluid characteristic sensing projection and signals indicative of a temperature of the fluid characteristic sensing projection are to be directed via the second signal connector. As discussed above, the signals indicative of resistance may be used to estimate a fluid depth. And the signals indicative of the temperature may be used to determine a rate of change of temperature of the fluid characteristic sensing projection.

Consistent with the foregoing description, an example fluid characteristic sensing device (e.g., fluid characteristic sensing device 300 in FIG. 3 and fluid characteristic sensing device 400 in FIG. 4) may have a fluid characteristic sensing projection (e.g., fluid characteristic sensing projection 308 and fluid characteristic sensing projection 408) that is connected to a circuit board (e.g., circuit board 302 and circuit board 402) of the fluid characteristic sensing device. The circuit board may be arranged to be a top-mount or a side-mount circuit board, by way of non-limiting example. The fluid characteristic sensing projection may comprise a first probe (e.g., first conductive component 310a and first conductive component 410a) and a second probe (e.g., second conductive component 310b and second conductive component 410b) that are connected to the circuit board at a first extremity of the first and the second probes. The first and the second probes may be connected together at a second extremity, such as by a conductive component connector. As discussed above, the first and the second probes may comprise silicon, such as, in one case, polysilicon, by non-limiting example. In another case, the probes may comprise a metal, such as steel, having a polysilicon coating. The fluid characteristic sensing device is to receive signals at the circuit board to enable a determination of resistance and temperature of the fluid characteristic sensing projection. The received signals may comprise one or more current pulses. The received signals may be directed from the circuit board, through the first probe, through the second probe, and back through the circuit board, such as to be directed out of the fluid characteristic sensing device via an interconnect. The received and directed signals are to be used to determine a rate of change of temperature of the fluid characteristic sensing projection.

Consistent with the above description, in one example, a device capable of enabling estimation of a fluid depth may comprise a first polysilicon probe and a second polysilicon probe (e.g., first and second conductive components 310a and 310b in FIG. 3 and first and second conductive components 410a and 410b in FIG. 4). The first and the second polysilicon probes may be connected via a conductive connector (e.g., conductive component connector 314 and conductive component connector 414) at a lower portion of the first and the second polysilicon probes. A circuit board of the device may have a first connector (e.g., connector 304 and connector 404) to the first polysilicon probe. The circuit board may also have a second connector (e.g., connector 306 and connector 406) to the second polysilicon probe arranged on the circuit board. The first connector is to receive signals to be directed through the first and the second polysilicon probes to enable fluid depth estimations. In response to the signals to be received at the first connector, signals are to be directed via the first polysilicon probe, the second polysilicon probe, and the second connector. The received and directed signals are to enable determination of a resistance of the first and the second polysilicon probes and determination of a rate of change of temperature of the first and the second polysilicon probes. In one example, the device may be arranged in a reservoir, such as a reservoir containing printing fluid.

FIGS. 5A and 5B illustrate side-mount and top-mount fluid characteristic sensing devices 500, respectively, shown in a fluid reservoir 550. A reception mechanism 552 is shown capable of connecting to fluid characteristic sensing device 500. Reception mechanism 552 may comprise one or more electrical interconnects capable of forming a communicative connection with interconnects (e.g., interconnects 318 in FIG. 3 and interconnects 418 in FIG. 4) of a fluid characteristic sensing device 500. In one implementation, reception mechanism 552 may be arranged on the interior of fluid reservoir 550 to receive fluid characteristic sensing device 500, as shown. In another implementation however, interconnects (e.g., 318 and 418) may extrude out of a portion of reservoir 550, and reception mechanism 552 may be arranged on the exterior of reservoir 550. For instance, in one such case, reception mechanism 552 may not be arranged on reservoir 550, but may instead be a portion of a system to which reservoir 550 and fluid characteristic sensing device 500 may be connected. For an example printer, reception mechanism 552 may be arranged on a portion of the printer and may be capable of connecting and disconnecting from reservoir 550 and fluid characteristic sensing device 500, such as to enable replacement of reservoir 550 and fluid characteristic sensing device 500 upon exhaustion of printing fluid within reservoir 550, for example.

FIGS. 5A and 5B show reservoir 550 arranged having a non-angled lower portion for simplicity. In other cases, reservoir 550 may have a lower portion angled towards a fluid port through which fluid may exit reservoir 550. Such an angled arrangement may facilitate fluid circulation and may help avoid fluid waste, such as by allowing gravity to cause the fluid to collect at the fluid port.

FIGS. 5A and 5B show multiple fluid levels 555-563, distinguished using different pattern fills. Consistent with the above discussion, current pulses may be received through reception mechanism 552 and into fluid characteristic sensing device 500. The received current pulse may enable a resistance determination and a determination of a rate of change of temperature. For instance, as discussed above, the received current pulses may travel through a first portion of fluid characteristic sensing projection 508, such as a second conductive component 510b. The current pulse may travel through a second portion of fluid characteristic sensing projection 508, such as a first conductive component 510a. The current pulse may be subsequently directed out of fluid characteristic sensing device 500, such as via reception mechanism 552.

In one case, the current pulse may be used to determine a resistance of fluid characteristic sensing projection 508. The current pulse may be used to heat fluid characteristic sensing projection 508 and determine a temperature of fluid characteristic sensing projection 508. A time for the temperature of fluid characteristic sensing projection 508 to return to a steady state temperature may also be determined. The to be determined resistance and rate of change of temperature values enabled by fluid characteristic sensing device 500 may be used in order to estimate a fluid depth in one example case. For instance, a first resistance and a first rate of change of temperature may correspond to a fluid level illustrated by fluid level 555 in FIGS. 5A and 5B. A second resistance and a second rate of change of temperature may correspond to a fluid level illustrated by fluid level 557. A third resistance and a third rate of change of temperature may correspond to a fluid level illustrated by fluid level 559. A fourth resistance and a fourth rate of change of temperature may correspond to a fluid level illustrated by fluid level 561. And a fifth resistance and a fifth rate of change of temperature may correspond to a fluid level illustrated by 563. Etc.

It may be that arriving at similar fluid level determinations may confirm an accuracy of the fluid level estimation. However, at times, the fluid level estimations may differ. By way of non-limiting example, a fluid depth estimation based on resistance may suggest fluid depth corresponding to fluid level 555, while a fluid depth estimation based on a rate of change of temperature may suggest fluid depth corresponding to fluid level 557. In such a case, it may be possible to use one determination (e.g., rate of change of temperature) to reconcile another determination (e.g., resistance), and vice versa. By way of further example, fluid level estimations based on different characteristics of fluid characteristic sensing projection 508 may be averaged.

It is noted that while the foregoing examples described processing occurring external to a fluid characteristic sensing device, in at least some cases, an example fluid characteristic sensing device may comprise a processor to, for example, estimate fluid depth based on resistance and temperature.

As should be apparent based on the foregoing examples and discussion, a fluid characteristic sensing device may comprise a fluid characteristic sensing projection comprising two portions. The two portions may comprise a Si-based material. For example, in one case, the two portions of the fluid characteristic sensing projection may comprise polysilicon. In another example, fluid characteristic sensing projection portions may comprise a metal wire covered with polysilicon. The two portions of the fluid characteristic sensing projection may be connected to be in electrical communication. Signals may be received and directed through the two portions of the fluid characteristic sensing projection. The received and directed signals are to be used to determine a resistance of the fluid characteristic sensing projection. The received and directed signals are also be used to determine a rate of change of temperature of the fluid characteristic sensing projection. For example, the signals may be used in order to determine a temperature of the fluid characteristic sensing projection subsequent to a heating current pulse. A time for the temperature of the fluid characteristic sensing projection to return to a steady state temperature may also be determined. As noted above, among other things, fluid characteristic estimations, such as to resistance and temperature, may enable fluid depth, by way of non-limiting example. Estimations of fluid depth based on fluid characteristic sensing projection resistance may be used in conjunction with estimations of fluid depth based on a rate of change of temperature.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A device comprising:
a first signal connector and a second signal connector; and
a fluid characteristic sensing projection comprising a first conductive component connected to the first signal connector and a second conductive component connected to the second signal connector, wherein the first and second conductive components are connected at one extremity;
wherein the fluid characteristic sensing projection is to receive, through the first signal connector, signals for estimation of fluid depth, and responsive to the to be received signals, signals indicative of a resistance of the fluid characteristic sensing projection and signals indicative of a temperature of the fluid characteristic sensing projection are to be directed via the second signal connector.

2. The device of claim 1, wherein the first signal connector and the second signal connector are communicatively connected to a side-mount interconnect.

3. The device of claim 1, wherein the first and the second conductive components are connected at the one extremity using a conductive connector.

4. The device of claim 1, wherein the first conductive component comprises silicon (Si).

5. The device of claim 1, wherein the first conductive component comprises polysilicon.

6. The device of claim 1, wherein the signals indicative of the resistance of the fluid characteristic sensing projection and the signals indicative of the temperature of the fluid sensing projection are to be used to yield a resistance value and a rate of change of temperature value.

7. The device of claim 1 further comprising a printing fluid reservoir.

8. A fluid characteristic sensing device comprising:
a fluid characteristic sensing projection connected to a circuit board of the fluid characteristic sensing device, the fluid characteristic sensing projection comprising a first probe and a second probe connected to the circuit board at a first extremity of the fluid characteristic sensing projection, the first and the second probes connected together at a second extremity of the fluid characteristic sensing projection, the first and the second probes comprising silicon (Si);
wherein the fluid characteristic sensing device is to receive signals at the circuit board to enable determination of resistance and temperature of the fluid characteristic sensing projection, the received signals to be directed from the circuit board, through the first probe, through the second probe, back to the circuit board and out via an interconnect of the circuit board, wherein the received and directed signals are to be used to determine a rate of change of temperature of the fluid characteristic sensing projection.

9. The fluid characteristic sensing device of claim 8, wherein the first and the second probes comprise a metal coated with Si.

10. The fluid characteristic sensing device of claim 9, wherein the Si comprises polysilicon.

11. The fluid characteristic sensing device of claim 9, wherein the metal comprises steel.

12. The fluid characteristic sensing device of claim 8, wherein the circuit board of the fluid characteristic sensing device enables a top-mount orientation.

13. The fluid characteristic sensing device of claim 8, wherein the first and the second probes are connected via a conductive connector.

14. A device comprising:
a first polysilicon probe and a second polysilicon probe connected via a conductive connector at a lower portion of the first and the second polysilicon probes;
a first connector to the first polysilicon probe arranged on a circuit board of the device;
a second connector to the second polysilicon probe also arranged on the circuit board; and
wherein the first connector is to receive signals to be directed through the first and the second polysilicon probes to enable fluid characteristic sensing;
and further wherein responsive to the signals to be received at the first connector, signals are to be directed via the first polysilicon probe, the second polysilicon probe, and the second connector to enable determination of a resistance of the first and the second polysilicon probes, and determination of a rate of change of temperature of the first and the second polysilicon probes.

15. The device of claim 14, further comprising a printing fluid reservoir.
